(19) United States
(12) Patent Application Publication
(10) Pub. No.: US 2021/0065543 A1
(43) Pub. Date: Mar. 4, 2021

(54) Method, Device, and System of Traffic Light Control Utilizing Virtual Detectors

(71) Applicant: Axilion Ltd., Haifa (IL)

(72) Inventor: Ilan Weizman, Haifa (IL)

(21) Appl. No.: 16/957,727

(22) PCT Filed: Dec. 26, 2018
(86) PCT No.: PCT/IL2018/051390

§ 371 Date: Jun. 25, 2020

Related U.S. Application Data
(60) Provisional application No. 62/612,447, filed on Dec. 31, 2017.

(51) Int. Cl. G08G 1/08; G08G 1/01; G06T 7/20

(52) U.S. Cl. CPC G08G 1/08; G08G 1/012; G06T 2207/30268; G06T 2207/30236; G06T 2207/30242; G06T 7/20

(57) ABSTRACT

Method, device, and system of traffic light control utilizing virtual detectors. A system includes an input emulator which receives signals from one or more remote virtual detectors of vehicular traffic, directly via wired or wireless communication links, or indirectly via a remote computer server. The input emulator generates, based on the received signals, an output command indicating to a co-located Traffic Light Controller (TLC) a particular green-light timing allocation scheme; and then transfers the output command over a wired connection to the co-located TLC for implementation there.

### CROSS-REFERENCE TO RELATED APPLICATIONS

This patent application claims priority and benefit from U.S. patent application No. 62/612,447, filed on Dec. 31, 2017, which is hereby incorporated by reference in its entirety.

### FIELD

The present invention is related to vehicular traffic control.

### BACKGROUND

Millions of people utilize cars, vans, trucks, buses, taxis, and various other types of vehicle, in order to travel or to reach a desired destination. Various route segments, such as a road, a street, an avenue, or a boulevard, connect various parts of a town or city.

An intersection is where two or more roads meet or cross. The vehicular traffic in or near some intersections is controlled via traffic signs, for example, a Stop sign or a Yield sign. In some intersections, particularly those that connect busy or high-traffic roads, a traffic light mechanism is utilized to organize the traffic; for example, displaying a red light to vehicles that are commanded to stop, and displaying a green light to vehicles that are commanded to go.

### SUMMARY

The present invention may include, for example, systems, devices, and methods of a traffic light system utilizing virtual detectors.

In contrast with some conventional Traffic Light Control (TLC) systems, in which a physical wired loop (or a locally located camera with direct wired/wireless connection to the TLC) is placed on the road and transmits a wired/wireless signal to a TLC box as vehicles pass over the wired loop, the present invention provides and utilizes non-wired virtual detectors and sensors that do not require a wired loop and/or a wire and/or a camera with wired/wireless connection and/or cable to transmit signals. The present invention enables efficient conversion of a conventional TLC into a Smart-TLC that can receive signals that reflect real-time traffic information that was collected by a remote server from virtual sensor(s) or virtual detector(s).

For example, instead of connecting a TLC to a hardware connector of a hardware-based detector (such as a loop detector, or a local imager or video camera or thermal imager or a local radar detector, or a local Wi-Fi or Bluetooth transceiver that detects nearby cars and pedestrians) that is physically connected to the TLC via an electric cable or Wi-Fi, the TLC connects, through a hardware connector, to an Input Emulator unit, which receives wirelessly from a remote server a signal that is then transferred from the Input Emulator to the TLC over the hardware connector, “as if” it arrived from a physical loop detector; whereas in fact, the signal was generated by the remote server, based on analysis of data sensed by one or more detectors, sensors, cameras, vehicular applications, and/or other traffic-related information sources.

The emulated signal, which reflects (or is based on) real-time traffic data, may then be used by the TLC, to set or to modify the allocation or distribution of red-light/green-light resources to the various roads or lanes or users of an intersection, based on pre-defined formula or criteria.

The present invention may provide other and/or additional benefits or advantages.

### BRIEF DESCRIPTION OF THE DRAWINGS

FIG. 1 is a schematic illustration of a prior art traffic system.

FIG. 2 is a schematic illustration of a traffic control system, in accordance with some demonstrative embodiments of the present invention.

### DETAILED DESCRIPTION OF THE PRESENT INVENTION

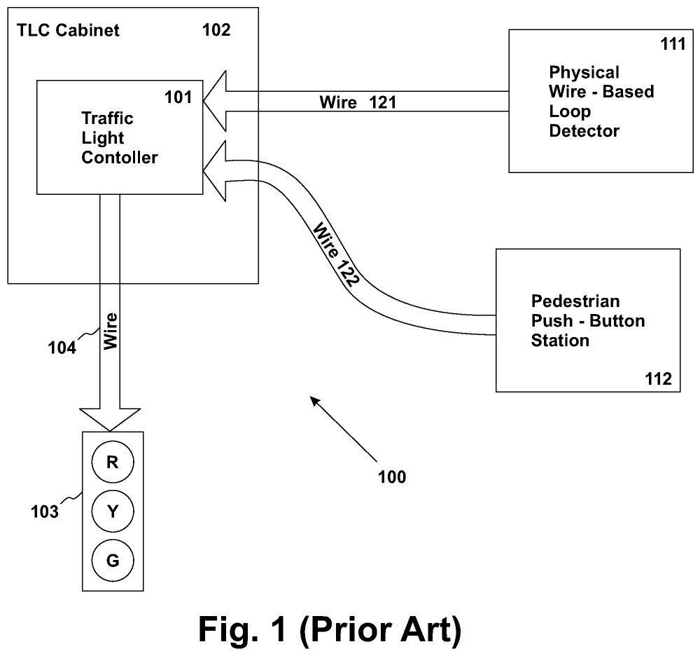

Reference is made to FIG. 1, which is a schematic illustration of a prior art traffic system 100. A traffic light box 103 is able to switch between illuminating red light, illuminating yellow light, and illuminating green light. The traffic light box 103 is connected via a physical wire or electric cable to a Traffic Light Controller (TLC) 101, which is typically implemented as a control panel and a processor that are located within a TLC cabinet 102, typically located at one corner of the intersection.

The conventional TLC 101 receives signals from one or more legacy detectors, over one or more physical wires or electric cables. For example, a physical wire-based loop detector 111 is placed on a road that leads to the intersection, and it sends (non-wirelessly) an electric signal over a physical wire 121 to the TLC 101 every time that a vehicle passes over the physical wire-based loop detector 111. Similarly, a pedestrian push-button station 112 is located at a corner of the intersection, and it sends (non-wirelessly) an electric signal over a physical wire 122 to the TLC 101 once a pedestrian pushes a push-button indicating a request to cross the road walking.

The Applicants have realized that a TLC relies on legacy, physical, wire-based (or wireless), traffic detectors, which are typically physically connected to the TLC via an electric cable; and such legacy detectors may be cumbersome, error-prone, expensive to produce, expensive to install, and expensive to maintain.

The Applicants have also realized that a conventional TLC may operate inefficiently in some situations; particularly when it allocates a fixed time-slot of green-light signal to a road in a manner that disregards the current actual occupancy of that road and/or of other roads that arrive to the same intersection.

The Applicants further realized that the reliance of a conventional TLC on legacy, physical, wire-based or wireless detectors, prevents and/or does not enable an efficient upgrade or conversion of traffic intersection to a “smart” TLC or intersection, which may be able to efficiently allocate or distribute the green-light or red-light budget(s) among the various roads or lanes or arms of the intersection.

The present invention enables a TLC to be wirelessly connected over a wired link (and/or via a wired link) to a remote server or to a cloud-based server; which in turn may collect data from one or more sensors or detectors over wireless links and/or wired links The remote server then provides its output signal to the TLC via a wireless communication signal, that is wirelessly received at a wireless receiver located within the TLC cabinet, and is then transferred over a local, wired, connector or cable from the wireless receiver to the TLC itself; such that the wireless receiver and its accompanying logic circuit are emulating, or are posing as, a legacy, physical, wire-based detector while in fact they are only a wireless receiver that receives a wireless signal from a remote server which in turn also receives or collects data from one or more wireless communication links and processes them remotely.

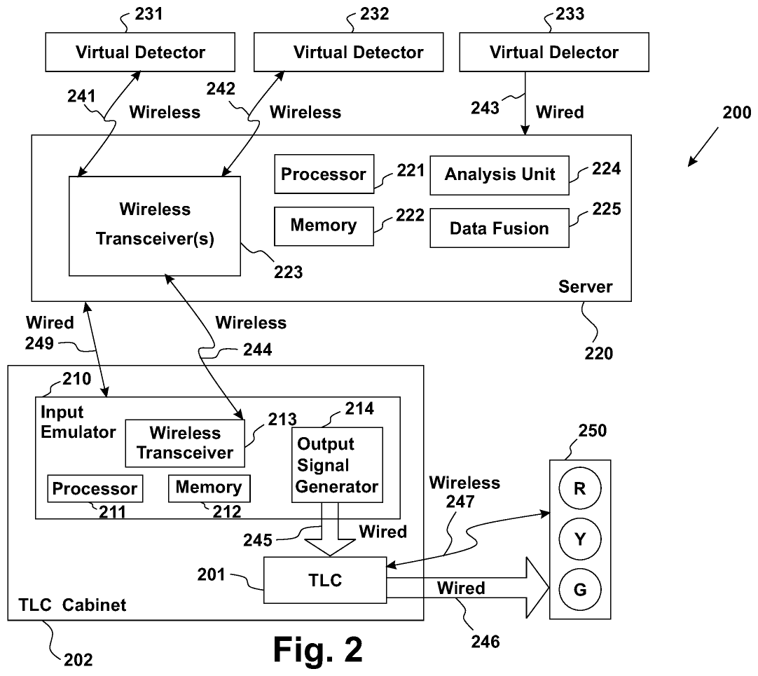

Reference is made to FIG. 2, which is a schematic illustration of a traffic control system 200, in accordance with some demonstrative embodiments of the present invention. System 200 may comprise one or more virtual detectors or virtual sensors, for example, virtual detectors 231, 232 and 233; which may sense, detect, measure and/or collect information via one or more means, and may send information over wireless links (241, 242) and/or wired links (243) to a server 220.

As a first example, virtual detector 231 may be a camera equipped with (or connected to) a computer vision unit or image analysis unit; may capture images of passing traffic; may analyze locally such captured images; and may wirelessly transmit traffic information to server 220 over a wireless communication link 241 (e.g., a cellular communication link; a Wi-Fi communication link; or the like). The traffic information may comprise, for example, an indication that a vehicle has passed a particular point or location; a speed of an approaching vehicle; a number of occupants of a passing vehicle (e.g., determined by image analysis of the vehicle); a type or other properties of the passing vehicle (e.g., electric car; truck; taxi); and/or other data which may be detected or deduced from one or more images of passing traffic.

As a second example, virtual detector 232 may be an infrastructure-based Vehicle-to-Infrastructure (V2I) wireless receiver, able to receive V2I messages or V2I signals from nearby vehicles or from passing vehicles. For example, a “smart vehicle” may pass, and may periodically, wirelessly, transmit a V2I message or signal, indicating to nearby infrastructure recipient(s) its own identity (e.g., a Tesla sedan car), its maximum occupancy (e.g., five occupants), its current actual occupancy (e.g., three occupants, as detected by the smart vehicle based on sensors of buckled seat-belts, or based on weight-sensors that are integrated in or under each seat), its destination (e.g., as known to the vehicular navigation system/mapping system/route-guidance system), its current speed, or the like. The virtual detector 232 may receive such data wirelessly from the passing vehicle; and may then wirelessly transmit that data (in whole, or in part, or in a processed form) to server 220 over a wireless communication link 242 (e.g., a cellular communication link; a Wi-Fi communication link; or the like).

As a third example, virtual detector 233 may be an Internet Protocol (IP) camera or an Internet-connected camera, able to capture and stream video or a sequence of images or frames. For example, raw images or raw footage are transferred from virtual detector 233, using a wired communication link 243 and/or using a wireless communication link, to server 220. Then, a memory unit 222 of server 220 may store the incoming data; and a processor 221 of server 221 may process or analyze the data. Particularly, for example, an Analysis Unit 224 may analyze the images and may apply a computer vision algorithm, in order to identify in image(s) one or more pedestrian(s) that are approaching the intersection and/or that are waiting for their green-light signal in order to cross the road. The Analysis Unit 224 may also check whether a pre-defined condition holds true; for example, whether the total number of identified pedestrians is equal or greater than a pre-defined threshold value (e.g., at least N pedestrians; at least 3 pedestrians; or the like).

In some embodiments, a Data Fusion unit 225 of server 220 may perform fusion of two or more of the data or data-items or data-streams that were received from the multiple virtual detectors 231-233, and/or may perform fusion of two or more of the traffic-related insights that were derived or deduced from such data.

For example, the data received from virtual detector 231 may indicate that there are currently no passing vehicles on Third Street on their way to the intersection, and/or that in the past 10 seconds there were no vehicles passing on Third Street on their way to the intersection. Additionally, the data received from virtual detector 233 may indicate that there are currently seven pedestrians waiting at the intersection to cross Third Street, which currently has green-light for cars and red-light for pedestrians. The Data Fusion unit 225 may fuse together these two data-items and may generate a decision that it would be beneficial to immediately switch the lights in the intersection, to green-light for these pedestrians and red-light for vehicular traffic.

In some embodiments, processor 221 of server 220, or the Analysis Unit 224 of server 220, or the Data Fusion unit 225 of server 220, may generate an output signal or an output message, at pre-defined time intervals, such as every T seconds (e.g., every 0.75 seconds, ever 1 second, every 1.4 seconds, or the like). In some embodiments, the message or the signal may be binary, or may have one of two possible values, such as 1 or 0, or True or False, or “Condition Holds True” or “Condition Does Not Hold True”, or “Activate” or “De-Activate”. The signal may be transmitted wirelessly, over a wireless communication link 244 (e.g., Wi-Fi link, cellular link, or the like) from a wireless transceiver 223 of server 220, to a wireless receiver or a wireless transceiver 213 of an Input Emulator unit 210 that is installed in or at a Traffic Light Control (TLC) cabinet 202; and/or, the signal may be transferred from server 220 to Input Emulator unit 210 over a wired connection 249 (e.g., copper wire, electric wire, electric cable, optic fiber, or the like).

The TLC cabinet 202 may comprise two main components: (i) a Traffic Light Controller (TLC) 201, able to control a Traffic Light Box 250 via a wired communication link 247 and/or via a wireless communication link 247; and (ii) the Input Emulator 210, which is connected to the TLC 201 via a wire or cable or other non-wireless connection or non-wireless connector (e.g., dry contacts, serial communication, RS-232 connector, RS-422 connector, SATA connector, PCI connector, USB connection, or the like).

The Input Emulator 210 comprises the wireless transceiver 213, which receives the signal(s) or message(s) or traffic commands or traffic insights from the remote server 220 over the wireless communication link 244. The Input Emulator 210 may further comprise, optionally, a memory unit 212 to store the incoming data or signals, a processor 211 or other controller to perform or to control the operations of the Input Emulator 210; and optionally, an Output Signal Generator 214 which generates, every T seconds, over a wired link 245 or a non-wireless connection or connector, a signal or a message or a command in a suitable format that is compatible with the input-format capabilities of TLC 201.

In some embodiments, the Input Emulator 210 may operate to provide to the TLC 201, a signal that was actually generated based on the sensing operations of the Virtual Detectors 231-233, whereas the signal is “posing” as if it was generated by, or as if it arrived from, a Physical Detector such as a physical wired loop detector or a physical pedestrian push-button station. The TLC 201 need not “know”, or cannot know, or cannot recognize, that the signal that is received at its input port or its input socket, over a non-wireless hardware connection, does not actually arrive from a physical detector that is hard-wired to the TLC 201 via an electric cable; but rater, actually arrives from an Emulator module that receives that signal (or an equivalent message) via Wireless transmission from remote server 220 which in turn had generated that signal based on data collected by one or more virtual detectors 231-233.

Accordingly, the present invention enables to convert a conventional TLC, located in a conventional TLC cabinet, that is pre-built to only receive a wired signal over a wired connection from a physical detector, into a “smart” TLC, having a very similar or almost-unchanged form-factor (e.g., having only the Emulator Unit attached to it), fitting inside the same TLC cabinet, but able to receive an emulated input signal that is actually based on data that a remote server has just derived from a set of virtual detectors and/or virtual sensors.

Some portions of the discussion may relate to vehicles, but the present invention may similarly apply to allocation of resources to other users of public spaces or roads or intersections, such as pedestrians, riders of bicycles or tricycles or scooters (e.g., motorized or non-motorized), and other users; and/or may apply to allocation of resources to vehicles by taking into account the pedestrians and/or such other users.

For demonstrative purposes, some portions of the discussion above or herein relate to green-light and/or to red-light; however, the present invention may be utilized with a tri-light or tri-state TLC or intersection, having red-light and yellow-light and green-light, with similar conditions or criteria applied to such TLC or intersection.

Some embodiments of the present invention may operate in conjunction with light-less traffic signaling systems, in which a green-light or a red-light is not necessarily illuminated or displayed, but rather, a “go” or “stop” (or “no go”) signal is transmitted from the traffic signaling system to one or more vehicles or recipients (e.g., a vehicle, a self-driving vehicle, an autonomous vehicle) via a suitable communication means (e.g., wireless signal, Wi-Fi signal, V2I communication, or the like).

Some embodiments, of the present invention may operate in conjunction with a “traffic actuated time-plan”, in which the green-light that can be allocated to a particular direction or road or lane or phase of the interaction, is pre-defined as a time-length T in the range of T1 to T1+T2 (for example, in the range of 10 seconds to 30 seconds, or in the range of 10 seconds to 10+20 seconds); such that at least T1 seconds are allocated as a default minimum green-light length, whereas the additional T2 seconds vary between 0 to T2 based on the vehicular traffic that is approaching and/or waiting at that direction and/or in other directions. In some embodiments, T2 may be dynamically set to zero, for example, in a left-lane signal upon detection that the left lane does not have any vehicles waiting and/or approaching to turn left.

Although portions of the discussion herein relate, for demonstrative purposes, to wired links and/or wired communications, some embodiments of the present invention are not limited in this regard, and may include one or more wired or wireless links, may utilize one or more components of wireless communication, may utilize one or more methods or protocols of wireless communication, or the like. Some embodiments may utilize wired communication and/or wireless communication.

It is noted that embodiments of the present invention may allow a TLC to communicate efficiently with (or to receive information from) various types of detectors and sensors, via wired links and/or wireless links; for example, from an electro-magnetic loop detector, a pedestrian push button, a camera or imager or video camera or thermal imager, a radar sensor or LIDAR sensor, a Bluetooth or Wi-Fi transceiver, or other units which may be connected to the local TLC via a wired link (e.g., a cable or wore) and/or via a direct wireless communication link (e.g., a via direct point-to-point wireless communication protocol.

Some embodiments include a system comprising: an input emulator, (a) to receive signals from one or more remote virtual detectors of vehicular traffic, and (b) to generate based on said signals an output command indicating to a co-located Traffic Light Controller (TLC) a particular green-light timing allocation scheme, and (c) to transfer said output command over a wired connection to said co-located TLC.

In some embodiments, the input emulator is to receive said signals indirectly from at least one remote virtual detector, via a remote computer server which (i) obtains raw data collected by said remote virtual detector and (ii) generates a data-item that indicates vehicular characteristics to said input emulator.

In some embodiments, the input emulator is to receive said signals indirectly from at least one remote virtual detector, via a remote computer server which (i) obtains raw data collected by said remote virtual detector and (ii) generates a data-item that indicates vehicular characteristics to said input emulator and (iii) further indicates to said input emulator at which geographical location said raw data was collected by said remote virtual detector.

In some embodiments, the input emulator is to receive said signals directly from at least one remote virtual detector, via a wireless communication link that connects between (i) said remote virtual detector and (ii) said input emulator that is co-located with said TLC.

In some embodiments, the input emulator is to receive said signals from at least a remote virtual detector which (i) captures images of approaching vehicular traffic, and (ii) performs image analysis of said images to determine characteristics of the approaching vehicular traffic.

In some embodiments, the input emulator is to receive said signals from at least a remote virtual detector which (i) captures images of approaching vehicular traffic, and (ii) performs image analysis of said images to determine the number of approaching vehicles and the velocity of approaching vehicles.

In some embodiments, the input emulator is to receive said signals from at least a remote virtual detector which (i) captures images of approaching vehicular traffic, and (ii) performs image analysis of said images to determine the number of approaching vehicles and the velocity of approaching vehicles; wherein said remote virtual detector operates independently from, and without relying on, any wired loop-cable that is placed on a road.

In some embodiments, the input emulator is to receive said signals from at least a remote virtual detector which (i) captures images of approaching vehicular traffic, and (ii) performs image analysis of said images to determine the number of passengers in approaching vehicles.

In some embodiments, the input emulator is to receive said signals from at least a remote virtual detector which (i) captures images of approaching vehicular traffic, and (ii) performs image analysis of said images to determine the number of passengers in approaching vehicles.

In some embodiments, the input emulator is to receive said signals from at least a remote virtual detector which obtains vehicular characteristics of an approaching vehicle via a direct Vehicle to Infrastructure communication link that is established directly between (i) said remote virtual detector and (ii) said approaching vehicle.

In some embodiments, the input emulator is to receive said signals from at least a remote virtual detector which obtains vehicular characteristics of an approaching vehicle via a direct Vehicle to Infrastructure communication link that is established directly between (i) said remote virtual detector and (ii) said approaching vehicle; wherein said signals indicate to said input emulator the number of current occupants of said approaching vehicle as communicated directly and wirelessly from said approaching vehicle to said remote virtual detector over said direct Vehicle to Infrastructure communication link.

In some embodiments, the input emulator is to receive said signals from at least a remote virtual detector which obtains vehicular characteristics of an approaching vehicle via a direct Vehicle to Infrastructure communication link that is established directly between (i) said remote virtual detector and (ii) said approaching vehicle; wherein said signals indicate to said input emulator the type of current occupants of said approaching vehicle as communicated directly and wirelessly from said approaching vehicle to said remote virtual detector over said direct Vehicle to Infrastructure communication link.

In some embodiments, the input emulator is to receive said signals from at least a remote virtual detector which obtains vehicular characteristics of an approaching vehicle via a direct Vehicle to Infrastructure communication link that is established directly between (i) said remote virtual detector and (ii) said approaching vehicle; wherein said signals indicate to said input emulator the type of cargo that is currently transported by said approaching vehicle as communicated directly and wirelessly from said approaching vehicle to said remote virtual detector over said direct Vehicle to Infrastructure communication link.

In some embodiments, the input emulator is to receive said signals from at least a remote virtual detector via a remote computer server which: (I) obtains vehicular characteristics data that was collected by said remote virtual detector with regard to vehicular characteristics of an approaching vehicle via a direct Vehicle to Infrastructure communication link that is established directly between (i) said remote virtual detector and (ii) said approaching vehicle, and (II) generates a data-item that indicates the vehicular characteristics to said input emulator.

In some embodiments, the input emulator is to receive said signals from at least a remote virtual detector via a remote computer server which: (I) obtains vehicular characteristics data that was collected by said remote virtual detector with regard to vehicular characteristics of an approaching vehicle via a direct Vehicle to Infrastructure communication link that is established directly between (i) said remote virtual detector and (ii) said approaching vehicle, and (II) generates a data-item that indicates the vehicular characteristics to said input emulator; wherein the vehicular characteristics data, that was collected by the remote virtual detector and that was communicated by the remote computer server to the input emulator, comprises at least an indication of the number of current occupants of an approaching vehicle as communicated directly from said approaching vehicle to said remote virtual detector over said direct Vehicle to Infrastructure communication link.

In some embodiments, the input emulator is to receive said signals from at least a remote virtual detector via a remote computer server which: (I) obtains vehicular characteristics data that was collected by said remote virtual detector with regard to vehicular characteristics of an approaching vehicle via a direct Vehicle to Infrastructure communication link that is established directly between (i) said remote virtual detector and (ii) said approaching vehicle, and generates a data-item that indicates the vehicular characteristics to said input emulator; wherein the vehicular characteristics data, that was collected by the remote virtual detector and that was communicated by the remote computer server to the input emulator, comprises at least an indication of the type of current occupants of an approaching vehicle as communicated directly from said approaching vehicle to said remote virtual detector over said direct Vehicle to Infrastructure communication link.

In some embodiments, the input emulator is to receive said signals from at least a remote virtual detector via a remote computer server which: (I) obtains vehicular characteristics data that was collected by said remote virtual detector with regard to vehicular characteristics of an approaching vehicle via a direct Vehicle to Infrastructure communication link that is established directly between (i) said remote virtual detector and (ii) said approaching vehicle, and (II) generates a data-item that indicates the vehicular characteristics to said input emulator; wherein the vehicular characteristics data, that was collected by the remote virtual detector and that was communicated by the remote computer server to the input emulator, comprises at least an indication of the current type of cargo in an approaching vehicle as communicated directly from said approaching vehicle to said remote virtual detector over said direct Vehicle to Infrastructure communication link.

In some embodiments, the input emulator is to receive said signals from at least a remote virtual detector which collects raw data and also performs at least partial analysis of said raw data prior to transmitting said signals directly to the input emulator.

In some embodiments, the input emulator is to receive said signals from at least a remote virtual detector which collects raw data and transmits the raw data to a remote computer server which in turn performs analysis of said raw data prior to transmitting said signals from the remote computer server to the input emulator.

Some embodiments include an apparatus comprising: a virtual detector, (a) to sense data about an approaching vehicle without relying on any wired cable located on a road, and (b) to transfer a signal indicating said data about the approaching vehicle to an input emulator that is co-located with a Traffic Light Control (TLC).

In some embodiments, the virtual detector is to transfer said signal to said input emulator directly via a wired communication link between the virtual detector and the input emulator.

In some embodiments, the virtual detector is to transfer said signal to said input emulator directly via a wireless communication link between the virtual detector and the input emulator.

In some embodiments, the virtual detector is to transfer said signal to said input emulator indirectly via a remote computer server which (i) receives signals from the virtual detector, and (ii) performs processing of said signals to determine characteristics of the approaching vehicle, and (iii) transmits to said input emulator a message indicating said characteristics of the approaching vehicle.

In some embodiments, the virtual detector is to transfer said signal to said input emulator via a direct communication link by emulating transfer of signals that are transferred from physical cable-based vehicular detectors.

In some embodiments, the virtual detector is to transfer said signal to said input emulator via indirect communication through a remote computer server which in turn emulates transfer of signals that are transferred from physical cable-based vehicular detectors.

In some embodiments, the signals that the input emulator receives from the virtual detector trigger said input emulator to transfer to said co-located TLC a command to implement a particular green-light timing scheme.

The present invention may be implemented by using hardware units, software units, processors, CPUs, DSPs, Programmable Logic Controllers (PLCs), integrated circuits, memory units, storage units, wireless communication modems or transmitters or receivers or transceivers, cellular transceivers, a power source, input units, output units, Operating System (OS), drivers, applications, and/or other suitable components.

The present invention may be implemented by using a special-purpose machine or a specific-purpose that is not a generic computer, or by using a non-generic computer or a non-general computer or machine. Such system or device may utilize or may comprise one or more units or modules that are not part of a “generic computer” and that are not part of a “general purpose computer”, for example, cellular transceivers, cellular transmitter, cellular receiver, GPS unit, location-determining unit, accelerometer(s), gyroscope(s), device-orientation detectors or sensors, device-positioning detectors or sensors, or the like.

The present invention may be implemented by using code or program code or machine-readable instructions or machine-readable code, which is stored on a non-transitory storage medium or non-transitory storage article (e.g., a CD-ROM, a DVD-ROM, solid state drive (SSD), portable Flash drive, Disk on Key, a physical memory unit, a physical storage unit), such that the program or code or instructions, when executed by a processor or a machine or a computer, cause such device to perform a method in accordance with the present invention.

Embodiments of the present invention may be utilized with a variety of devices or systems having a touch-screen or a touch-sensitive surface; for example, a smartphone, a cellular phone, a mobile phone, a smart-watch, a tablet, a handheld device, a portable electronic device, a portable gaming device, a portable audio/video player, an Augmented Reality (AR) device or headset or gear, a Virtual Reality (VR) device or headset or gear, a “kiosk” type device, a vending machine, an Automatic Teller Machine (ATM), a laptop computer, a desktop computer, a vehicular computer, a vehicular dashboard, a vehicular touch-screen, or the like.

The system(s) and/or device(s) of the present invention may optionally comprise, or may be implemented by utilizing suitable hardware components and/or software components; for example, processors, processor cores, Central Processing Units (CPUs), Digital Signal Processors (DSPs), circuits, Integrated Circuits (ICs), Programmable Logic Controller (PLC), controllers, memory units, registers, accumulators, storage units, input units (e.g., touch-screen, keyboard, keypad, stylus, mouse, touchpad, joystick, trackball, microphones), output units (e.g., screen, touch-screen, monitor, display unit, audio speakers), acoustic microphone(s) and/or sensor(s), optical microphone(s) and/or sensor(s), laser or laser-based microphone(s) and/or sensor(s), wired or wireless modems or transceivers or transmitters or receivers, GPS receiver or GPS element or other location-based or location-determining unit or system, network elements (e.g., routers, switches, hubs, antennas), and/or other suitable components and/or modules.

The system(s) and/or devices of the present invention may optionally be implemented by utilizing co-located components, remote components or modules, “cloud computing” servers or devices or storage, client/server architecture, peer-to-peer architecture, distributed architecture, and/or other suitable architectures or system topologies or network topologies.

In accordance with embodiments of the present invention, calculations, operations and/or determinations may be performed locally within a single device, or may be performed by or across multiple devices, or may be performed partially locally and partially remotely (e.g., at a remote server) by optionally utilizing a communication channel to exchange raw data and/or processed data and/or processing results.

Some embodiments may be implemented by using a special-purpose machine or a specific-purpose device that is not a generic computer, or by using a non-generic computer or a non-general computer or machine. Such system or device may utilize or may comprise one or more components or units or modules that are not part of a “generic computer” and that are not part of a “general purpose computer”, for example, cellular transceivers, cellular transmitter, cellular receiver, GPS unit, location-determining unit, accelerometer(s), gyroscope(s), device-orientation detectors or sensors, device-positioning detectors or sensors, or the like.

Some embodiments may be implemented as, or by utilizing, an automated method or automated process, or a machine-implemented method or process, or as a semi-automated or partially-automated method or process, or as a set of steps or operations which may be executed or performed by a computer or machine or system or other device.

Some embodiments may be implemented by using code or program code or machine-readable instructions or machine-readable code, which may be stored on a non-transitory storage medium or non-transitory storage article (e.g., a CD-ROM, a DVD-ROM, a physical memory unit, a physical storage unit), such that the program or code or instructions, when executed by a processor or a machine or a computer, cause such processor or machine or computer to perform a method or process as described herein. Such code or instructions may be or may comprise, for example, one or more of: software, a software module, an application, a program, a subroutine, instructions, an instruction set, computing code, words, values, symbols, strings, variables, source code, compiled code, interpreted code, executable code, static code, dynamic code; including (but not limited to) code or instructions in high-level programming language, low-level programming language, object-oriented programming language, visual programming language, compiled programming language, interpreted programming language, C, C++, C#, Java, JavaScript, SQL, Ruby on Rails, Go, Cobol, Fortran, ActionScript, AJAX, XML, JSON, Lisp, Eiffel, Verilog, Hardware Description Language (HDL, BASIC, Visual BASIC, Matlab, Pascal, HTML, HTML5, CSS, Perl, Python, PHP, machine language, machine code, assembly language, or the like.

Discussions herein utilizing terms such as, for example, “processing”, “computing”, “calculating”, “determining”, “establishing”, “analyzing”, “checking”, “detecting”, “measuring”, or the like, may refer to operation(s) and/or process(es) of a processor, a computer, a computing platform, a computing system, or other electronic device or computing device, that may automatically and/or autonomously manipulate and/or transform data represented as physical (e.g., electronic) quantities within registers and/or accumulators and/or memory units and/or storage units into other data or that may perform other suitable operations.

Some embodiments of the present invention may perform steps or operations such as, for example, “determining”, “identifying”, “comparing”, “checking”, “querying”, “searching”, “matching”, and/or “analyzing”, by utilizing, for example: a pre-defined threshold value to which one or more parameter values may be compared; a comparison between (i) sensed or measured or calculated value(s), and (ii) pre-defined or dynamically-generated threshold value(s) and/or range values and/or upper limit value and/or lower limit value and/or maximum value and/or minimum value; a comparison or matching between sensed or measured or calculated data, and one or more values as stored in a look-up table or a legend table or a list of reference value(s) or a database of reference values or ranges; a comparison or matching or searching process which searches for matches and/or identical results and/or similar results and/or sufficiently-close results, among multiple values or limits that are stored in a database or look-up table; utilization of one or more equations, formula, weighted formula, and/or other calculation in order to determine similarity or a match between or among parameters or values; utilization of comparator units, lookup tables, threshold values, conditions, conditioning logic, Boolean operator(s) and/or other suitable components and/or operations.

The terms “plurality” and “a plurality”, as used herein, include, for example, “multiple” or “two or more”. For example, “a plurality of items” includes two or more items.

References to “one embodiment”, “an embodiment”, “demonstrative embodiment”, “various embodiments”, “some embodiments”, and/or similar terms, may indicate that the embodiment(s) so described may optionally include a particular feature, structure, or characteristic, but not every embodiment necessarily includes the particular feature, structure, or characteristic. Repeated use of the phrase “in one embodiment” does not necessarily refer to the same embodiment, although it may. Repeated use of the phrase “in some embodiments” does not necessarily refer to the same set or group of embodiments, although it may.

As used herein, and unless otherwise specified, the utilization of ordinal adjectives such as “first”, “second”, “third”, “fourth”, and so forth, to describe an item or an object, merely indicates that different instances of such like items or objects are being referred to; and does not intend to imply as if the items or objects so described must be in a particular given sequence, either temporally, spatially, in ranking, or in any other ordering manner.

Some embodiments may comprise, or may be implemented by using, an “app” or application which may be downloaded or obtained from an “app store” or “applications store”, for free or for a fee, or which may be pre-installed on a computing device or electronic device, or which may be transported to and/or installed on such computing device or electronic device.

Functions, operations, components and/or features described herein with reference to one or more embodiments of the present invention, may be combined with, or may be utilized in combination with, one or more other functions, operations, components and/or features described herein with reference to one or more other embodiments of the present invention. The present invention may comprise any possible combinations, re-arrangements, assembly, re-assembly, or other utilization of some or all of the modules or functions or components that are described herein, even if they are discussed in different locations or different chapters of the above discussion, or even if they are shown across different drawings or multiple drawings, or even if they are depicted in any drawing(s) without necessarily being connected via a line or an arrow.

While certain features of the present invention have been illustrated and described herein, many modifications, substitutions, changes, and equivalents may occur to those skilled in the art. Accordingly, the claims are intended to cover all such modifications, substitutions, changes, and equivalents.

1. A system comprising:
an input emulator, (a) to receive signals from one or more remote virtual detectors of vehicular traffic, and (b) to generate based on said signals an output command indicating to a co-located Traffic Light Controller (TLC) a particular green-light timing allocation scheme, and (c) to transfer said output command over a wired connection to said co-located TLC.

2. The system of claim 1,
wherein the input emulator is to receive said signals indirectly from at least one remote virtual detector, via a remote computer server which (i) obtains raw data collected by said remote virtual detector and (ii) generates a data-item that indicates vehicular characteristics to said input emulator.

3. The system of claim 1,
wherein the input emulator is to receive said signals indirectly from at least one remote virtual detector, via a remote computer server which (i) obtains raw data collected by said remote virtual detector and (ii) generates a data-item that indicates vehicular characteristics to said input emulator and (iii) further indicates to said input emulator at which geographical location said raw data was collected by said remote virtual detector.

4. The system of claim 1,
wherein the input emulator is to receive said signals directly from at least one remote virtual detector, via a wireless communication link that connects between (i) said remote virtual detector and (ii) said input emulator that is co-located with said TLC.

5. The system of claim 1,
wherein the input emulator is to receive said signals from at least a remote virtual detector which (i) captures images of approaching vehicular traffic, and (ii) performs image analysis of said images to determine characteristics of the approaching vehicular traffic.

6. The system of claim 1,
wherein the input emulator is to receive said signals from at least a remote virtual detector which (i) captures images of approaching vehicular traffic, and (ii) performs image analysis of said images to determine the number of approaching vehicles and the velocity of approaching vehicles.

7. The system of claim 1,
wherein the input emulator is to receive said signals from at least a remote virtual detector which (i) captures images of approaching vehicular traffic, and (ii) performs image analysis of said images to determine the number of approaching vehicles and the velocity of approaching vehicles;
wherein said remote virtual detector operates independently from, and without relying on, any wired loop-cable that is placed on a road.

8. The system of claim 1,
wherein the input emulator is to receive said signals from at least a remote virtual detector which (i) captures images of approaching vehicular traffic, and (ii) performs image analysis of said images to determine the number of passengers in approaching vehicles.

9. The system of claim 1,
wherein the input emulator is to receive said signals from at least a remote virtual detector which (i) captures images of approaching vehicular traffic, and (ii) performs image analysis of said images to determine the number of passengers in approaching vehicles.

10. The system of claim 1,
wherein the input emulator is to receive said signals from at least a remote virtual detector which obtains vehicular characteristics of an approaching vehicle via a direct Vehicle to Infrastructure communication link that is established directly between (i) said remote virtual detector and (ii) said approaching vehicle.

11. The system of claim 1,
wherein the input emulator is to receive said signals from at least a remote virtual detector which obtains vehicular characteristics of an approaching vehicle via a direct Vehicle to Infrastructure communication link that is established directly between (i) said remote virtual detector and (ii) said approaching vehicle,
wherein said signals indicate to said input emulator the number of current occupants of said approaching vehicle as communicated directly and wirelessly from said approaching vehicle to said remote virtual detector over said direct Vehicle to Infrastructure communication link.

12. The system of claim 1,
wherein the input emulator is to receive said signals from at least a remote virtual detector which obtains vehicular characteristics of an approaching vehicle via a direct Vehicle to Infrastructure communication link that is established directly between (i) said remote virtual detector and (ii) said approaching vehicle,
wherein said signals indicate to said input emulator the type of current occupants of said approaching vehicle as communicated directly and wirelessly from said approaching vehicle to said remote virtual detector over said direct Vehicle to Infrastructure communication link.

13. The system of claim 1,
wherein the input emulator is to receive said signals from at least a remote virtual detector which obtains vehicular characteristics of an approaching vehicle via a direct Vehicle to Infrastructure communication link that is established directly between (i) said remote virtual detector and (ii) said approaching vehicle,
wherein said signals indicate to said input emulator the type of cargo that is currently transported by said approaching vehicle as communicated directly and wirelessly from said approaching vehicle to said remote virtual detector over said direct Vehicle to Infrastructure communication link.

14. The system of claim 1,
wherein the input emulator is to receive said signals from at least a remote virtual detector via a remote computer server which
(I) obtains vehicular characteristics data that was collected by said remote virtual detector with regard to vehicular characteristics of an approaching vehicle via a direct Vehicle to Infrastructure communication link that is established directly between (i) said remote virtual detector and (ii) said approaching vehicle,
(II) generates a data-item that indicates the vehicular characteristics to said input emulator.

15. The system of claim 1,
wherein the input emulator is to receive said signals from at least a remote virtual detector via a remote computer server which
(I) obtains vehicular characteristics data that was collected by said remote virtual detector with regard to vehicular characteristics of an approaching vehicle via a direct Vehicle to Infrastructure communication link that is established directly between (i) said remote virtual detector and (ii) said approaching vehicle,
(II) generates a data-item that indicates the vehicular characteristics to said input emulator;
wherein the vehicular characteristics data, that was collected by the remote virtual detector and that was communicated by the remote computer server to the input emulator, comprises at least an indication of the number of current occupants of an approaching vehicle as communicated directly from said approaching vehicle to said remote virtual detector over said direct Vehicle to Infrastructure communication link.

16. The system of claim 1,
wherein the input emulator is to receive said signals from at least a remote virtual detector via a remote computer server which
(I) obtains vehicular characteristics data that was collected by said remote virtual detector with regard to vehicular characteristics of an approaching vehicle via a direct Vehicle to Infrastructure communication link that is established directly between (i) said remote virtual detector and (ii) said approaching vehicle,
(II) generates a data-item that indicates the vehicular characteristics to said input emulator;
wherein the vehicular characteristics data, that was collected by the remote virtual detector and that was communicated by the remote computer server to the input emulator, comprises at least an indication of the type of current occupants of an approaching vehicle as communicated directly from said approaching vehicle to said remote virtual detector over said direct Vehicle to Infrastructure communication link.

17. The system of claim 1,
wherein the input emulator is to receive said signals from at least a remote virtual detector via a remote computer server which
(I) obtains vehicular characteristics data that was collected by said remote virtual detector with regard to vehicular characteristics of an approaching vehicle via a direct Vehicle to Infrastructure communication link that is established directly between (i) said remote virtual detector and (ii) said approaching vehicle,
(II) generates a data-item that indicates the vehicular characteristics to said input emulator;
wherein the vehicular characteristics data, that was collected by the remote virtual detector and that was communicated by the remote computer server to the input emulator, comprises at least an indication of the current type of cargo in an approaching vehicle as communicated directly from said approaching vehicle to said remote virtual detector over said direct Vehicle to Infrastructure communication link.

18. The system of claim 1,
wherein the input emulator is to receive said signals from at least a remote virtual detector which collects raw data and also performs at least partial analysis of said raw data prior to transmitting said signals directly to the input emulator.

19. The system of claim 1,
wherein the input emulator is to receive said signals from at least a remote virtual detector which collects raw data and transmits the raw data to a remote computer server which in turn performs analysis of said raw data prior to transmitting said signals from the remote computer server to the input emulator.

20. An apparatus comprising:
a virtual detector, (a) to sense data about an approaching vehicle without relying on any wired cable located on a road, and (b) to transfer a signal indicating said data about the approaching vehicle to an input emulator that is co-located with a Traffic Light Control (TLC).

21. The apparatus of claim 20,
wherein the virtual detector is to transfer said signal to said input emulator directly via a wired communication link between the virtual detector and the input emulator.

22. The apparatus of claim 20,
wherein the virtual detector is to transfer said signal to said input emulator directly via a wireless communication link between the virtual detector and the input emulator.

23. The apparatus of claim 20,
wherein the virtual detector is to transfer said signal to said input emulator indirectly via a remote computer server which (i) receives signals from the virtual detector, and (ii) performs processing of said signals to determine characteristics of the approaching vehicle, and (iii) transmits to said input emulator a message indicating said characteristics of the approaching vehicle.

24. The apparatus of claim 20,
wherein the virtual detector is to transfer said signal to said input emulator via a direct communication link by emulating transfer of signals that are transferred from physical cable-based vehicular detectors.

25. The apparatus of claim 20,
wherein the virtual detector is to transfer said signal to said input emulator via indirect communication through a remote computer server which in turn emulates transfer of signals that are transferred from physical cable-based vehicular detectors.

26. The apparatus of claim 20,
wherein the signals that the input emulator receives from the virtual detector trigger said input emulator to transfer to said co-located TLC a command to implement a particular green-light timing scheme.
